(19) United States
(12) Patent Application Publication
(10) Pub. No.: US 2019/0279286 A1
(43) Pub. Date: Sep. 12, 2019

(54) CAR-SHARING MANAGEMENT APPARATUS, CAR-SHARING SYSTEM, CAR-SHARING MANAGEMENT METHOD, AND NON-TRANSITORY COMPUTER-READABLE STORAGE MEDIUM STORING PROGRAM

(71) Applicant: Toyota Jidosha Kabushiki Kaisha, Toyota-shi Aichi-ken (JP)

(72) Inventors: Saori Tanabe, Nisshin-shi Aichi-ken (JP); Hiroshi Kawai, Kasugai-shi Aichi-ken (JP); Teruko Ikegami, Toyota-shi Aichi-ken (JP)

(73) Assignee: Toyota Jidosha Kabushiki Kaisha, Toyota-shi Aichi-ken (JP)

(21) Appl. No.: 16/296,743

(22) Filed: Mar. 8, 2019

(30) Foreign Application Priority Data
Mar. 12, 2018 (JP) 2018-044432

(51) Int. Cl. G06Q 30/06; G08G 1/14; G06Q 10/02

(52) U.S. Cl. CPC G06Q 30/0645; G06Q 10/02; G08G 1/148

(57) ABSTRACT

A car-sharing management apparatus obtains the number of parking spaces available for reservation by adding the number of virtual parking spaces to the number of actual vacant parking spaces at a destination station and determines whether vehicle rental reservation is possible based on the number of parking spaces available for reservation at the destination station.

### CROSS-REFERENCE TO RELATED APPLICATIONS

This application claims priority to Japanese Patent Application No. 2018-044432 filed on Mar. 12, 2018, which is incorporated herein by reference in its entirety including the specification, drawings and abstract.

### BACKGROUND

### 1. Technical Field

The present disclosure relates to a car-sharing management apparatus, a carsharing system, a car-sharing management method, and a non-transitory computer-readable storage medium storing a program.

### 2. Description of Related Art

Currently, car-sharing services that allow a plurality of users to use a vehicle jointly are becoming widely available. Recently, in addition to a round-trip service, in which a user returns a rented vehicle to the same station where the vehicle are rented, a one-way trip service is proposed, in which a user returns a rented vehicle to a station (destination station) different from the station (origin station) where the vehicle are rented. Moreover, for the one-way trip car-sharing service, a system that allows a user to reserve a parking space at the destination station simultaneously with reserving the vehicle is proposed (see, for example, Japanese Unexamined Patent Application Publication No. 2017-68449 (JP 2017-68449 A)).

### SUMMARY

It is described that when a system as disclosed in JP 2017-68449 A is employed, it is possible to prevent cases in which a user is unable to rent a vehicle because parking spaces at a destination station are reserved by other users. However, even when the system in the related art is employed, the user cannot make a reservation when there are no vacant parking spaces at the destination station.

FIG. 2 illustrates an example in which one vehicle V is heading to a destination station 200 from an origin station 100, and five vehicles V are available for reservation at the origin station 100. However, when there are only four vacant parking spaces P at the destination station 200, there are no vacant parking spaces for two of the five vehicles V of the origin station 100, and thus a user cannot make a reservation for these two vehicles V.

The present disclosure provides a car-sharing management apparatus, a car-sharing system, a car-sharing management method, and a non-transitory computer-readable storage medium which are able to provide more opportunities for users to reserve a vehicle when determining whether vehicle rental reservation is possible based on the number of vacant parking spaces at the destination station.

The car-sharing management apparatus according to a first aspect of the present disclosure is configured to determine whether vehicle rental reservation is possible based on the number of parking spaces available for reservation at a destination station. The car-sharing management apparatus is configured to obtain the number of parking spaces available for reservation by adding the number of virtual parking spaces to the number of actual vacant parking spaces at the destination station.

With the above configuration, whether vehicle rental reservation is possible is determined based on the number of parking spaces available for reservation which is larger than the number of the actual vacant parking spaces at the destination station. Accordingly, the number of vehicles available for reservation can be increased compared to a case in which whether vehicle rental reservation is possible is determined based on the number of actual vacant parking spaces at the destination station. In other words, according to the first aspect, users can obtain more opportunities to reserve a vehicle, since the users can also reserve virtual parking spaces, even when the actual vacant parking spaces are fully reserved. Here, “a virtual parking space” refers to a virtual parking space set by predicting movements of the vehicles parked at the destination station according to a dispatch-deadhead schedule.

The car-sharing management apparatus according to the first aspect of the present disclosure may include a parking space determination unit configured to determine the number of parking spaces available for reservation. When the car-sharing management apparatus receives a reservation request from a user via a user terminal, the car-sharing management apparatus can determine whether a vehicle rental reservation is possible based on the number of parking spaces available for reservation determined by the parking space determination unit. Here, the parking space determination unit can determine the number of virtual parking spaces based on the dispatch-deadhead schedule of the vehicle, or the dispatch-deadhead capability of autonomous vehicle parked at the destination station.

Furthermore, the car-sharing system according to a second aspect of the present disclosure includes an origin station, a destination station where the vehicles that are rented at the origin station are to be parked, and the car-sharing management apparatus described above. The destination station may be the same as or different from the origin station.

The car-sharing management method according to a third aspect of the present disclosure includes a step of obtaining the number of parking spaces available for reservation by adding the number of virtual parking spaces to the number of actual vacant parking spaces at a destination station, and a step of determining whether vehicle rental reservation is possible based on the number of parking spaces available for reservation.

A fourth aspect of the present disclosure is a non-transitory computer-readable storage medium storing a program. The program includes commands for causing the computer to obtain the number of parking spaces available for reservation by adding the number of virtual parking spaces to the number of actual vacant parking spaces at a destination station, and determine whether vehicle rental reservation is possible based on the number of parking spaces available for reservation.

According to each aspect of the present disclosure, when determining whether vehicle rental reservation is possible based on the number of parking spaces at the destination station, it is possible to provide users with more opportunities to reserve a vehicle.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a block diagram illustrating a configuration of a car-sharing system according the present disclosure; and

FIG. 2 is a diagram illustrating a configuration of the car-sharing system of a related art.

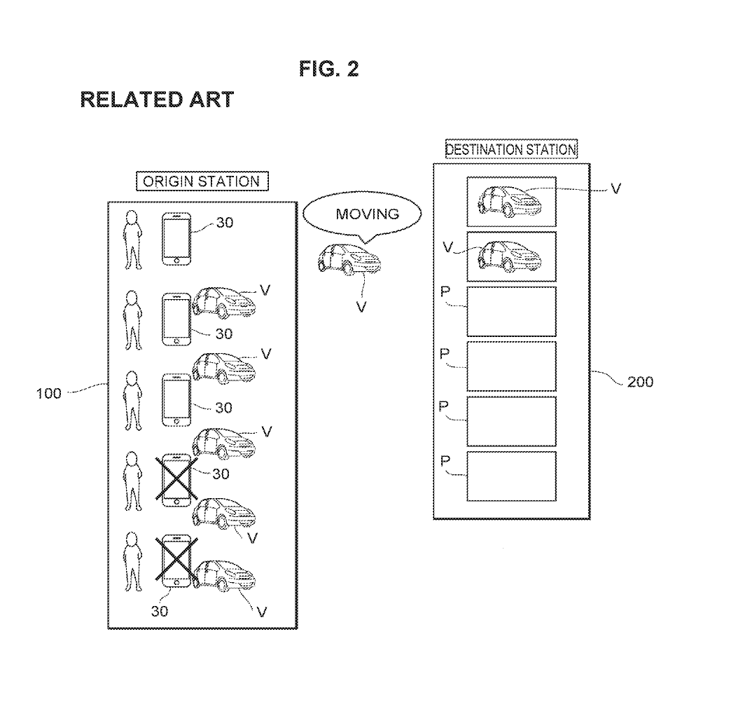

### DETAILED DESCRIPTION OF EMBODIMENTS

Hereinafter, an embodiment of the present disclosure will be described with reference to each drawing. The embodiment below is an example to describe the present disclosure, but the present disclosure is not limited thereto. In addition, other variations may be made within the technical scope of the disclosure.

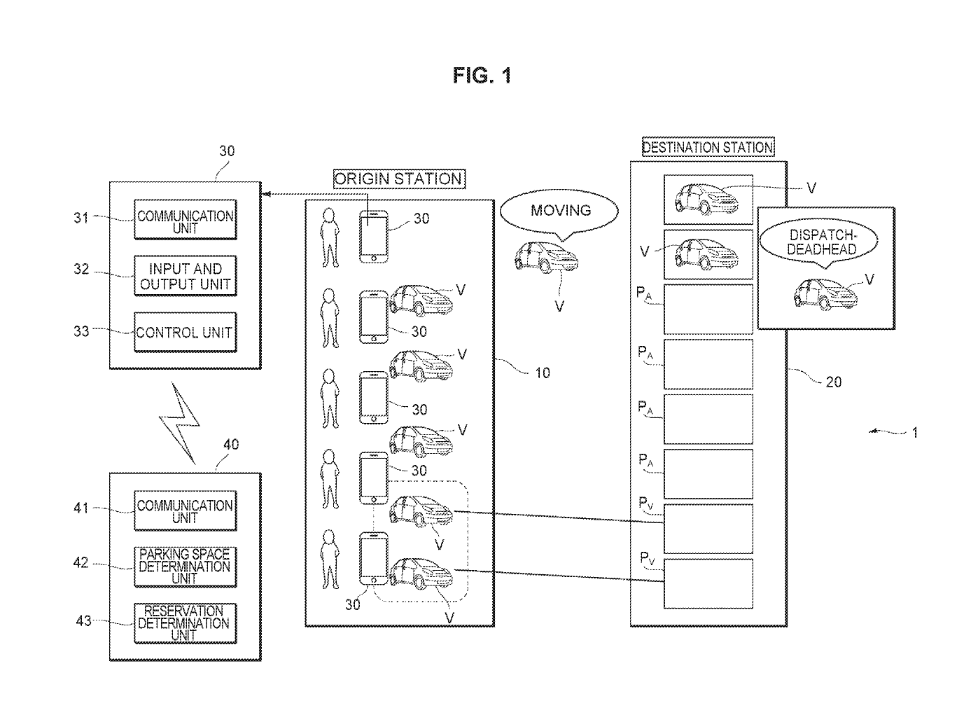

First, a configuration of a car-sharing system 1 according to the embodiment of the present disclosure will be described with reference to FIG. 1. The car-sharing system 1 according to the present embodiment is a one-way trip system in which a user returns a rented vehicle to a station (destination station) different from the station (origin station) where the vehicle are rented.

As illustrated in FIG. 1, the car-sharing system 1 according to the present embodiment includes an origin station 10, a destination station 20, a user terminal 30, and a car-sharing management apparatus 40.

The origin station 10 has parking spaces for parking the vehicles V to be rented to users. The destination station 20 has parking spaces where the vehicles V that are rented at the origin station 10 are to be parked for return. The destination station 20 is located at a place different from the origin station 10.

Both the user terminal 30 and the car-sharing management apparatus 40 may include an information processing apparatus (computer) having a memory storing various control programs or data and a Central Processing Unit (CPU) which reads and executes the various control programs or data stored in the memory.

The user terminal 30 is a portable terminal device carried by the user. The user terminal 30 includes a communication unit 31, an input and output unit 32, and a control unit 33. The communication unit 31 communicates with the car-sharing management apparatus 40 via the internet or the like. The input and output unit 32 receives an input made by the user, and provides information to the user. The control unit 33 generates a reservation request signal to be transmitted to the car-sharing management apparatus 40 based on reservation request information input via the input and output unit 32 and generates a user interface display based on the data received from the car-sharing management apparatus 40.

When the car-sharing management apparatus 40 receives a reservation request from the user via the user terminal 30, the car-sharing management apparatus 40 determines whether vehicle rental reservation is possible based on the number of parking spaces available for reservation at the destination station 20. The car-sharing management apparatus 40 includes a communication unit 41 configured to communicate with the user terminal 30, a parking space determination unit 42, and a reservation determination unit 43.

The parking space determination unit 42 derives the number of vacant parking spaces (actual parking spaces) P_{A} among the parking spaces at the destination station 20 based on, for example, past reservation history, sets the number of virtual parking spaces P_{V}, and calculates (determines) the number of parking spaces available for reservation by adding the number of the virtual parking spaces P_{V} to the number of actual vacant parking spaces P_{A}. Here, “virtual parking spaces” means virtual parking spaces set in the anticipation that vehicles V parked at the destination station 20 (two vehicles V in the example of FIG. 1) will leave the destination station 20 according to the dispatch-deadhead schedules of the vehicles.

The parking space determination unit 42 can set the number of virtual parking spaces P_{V} based on the dispatch-deadhead schedule. For example, the largest number of virtual parking spaces P_{V} (for example, three parking spaces) can be assigned to the time slots (for example, 19:00 to 21:00) when the largest number of staff members are deployed for vehicle dispatch-deadhead at the destination station 20 due to the largest number of expected users. Moreover, a relatively large number of virtual parking spaces P_{V} (for example, two parking spaces) can be assigned to the time slots (for example, 7:00 to 11:00 and 16:00 to 18:00) when a relatively large number of staff members are deployed for vehicle dispatch-deadhead at the destination station 20 due to a relatively large number of expected users. Meanwhile, a relatively small number of virtual parking spaces P_{V} (for example, one parking space) can be assigned to the time slots (for example, 12:00 to 15:00) when a relatively small number of staff members are deployed for vehicle dispatch-deadhead at the destination station 20 due to a relatively small number of expected users.

Furthermore, when the vehicles V parked at the destination station 20 are autonomous vehicles, the parking space determination unit 42 can determine the number of virtual parking spaces P_{V} based on the dispatch-deadhead capabilities of the autonomous vehicles. For example, when an autonomous vehicle is programmed to be autonomously delivered or returned in relatively short cycles due to a relatively large number of requests from users and is parked at the destination station 20, the parking space determination unit 42 can determine that the autonomous vehicle has a relatively high dispatch-deadhead capability, and set a relatively large number of virtual parking spaces P_{V}. On the other hand, when the autonomous vehicle is programmed to be autonomously delivered or returned in relatively long cycles due to a relatively small number of requests from users and is parked at the destination station 20, the parking space determination unit 42 can determine that the autonomous vehicle has a relatively low dispatch-deadhead capability, and set a relatively small number of virtual parking spaces P_{V}.

The reservation determination unit 43 determines whether vehicle rental reservation is possible based on the reservation request transmitted from the user terminal 30 and the number of parking spaces available for reservation determined by the parking space determination unit 42. For example, the reservation determination unit 43 determines that vehicle rental reservation is possible when, at the time of receiving a reservation request, the number of parking spaces available for reservation is one or more (i.e., there are remaining parking spaces available for reservation). Conversely, the reservation determination unit 43 determines that vehicle rental reservation is impossible when, at the time of receiving a reservation request, the number of parking spaces available for reservation is zero (i.e., there are no parking spaces available for reservation).

Next, a method for using the car-sharing system 1 according to the present embodiment will be described.

First, when the user inputs reservation request information via the input and output unit 32 of the user terminal 30, the control unit 33 of the user terminal 30 generates a reservation request signal based on the input reservation request information, and transmits the generated reservation request signal to the car-sharing management apparatus 40 via the communication unit 31.

In the car-sharing management apparatus 40, the communication unit 41 receives the reservation request signal transmitted from the user terminal 30, and the reservation determination unit 43 determines whether vehicle rental reservation is possible based on the number of parking spaces available for reservation determined by the parking space determination unit 42. FIG. 1 illustrates an example in which one vehicle V is heading to the destination station 20 from the origin station 10, and five vehicles V are at the origin station 10. In this case, even when there are only four actual vacant parking spaces P_{A} at the destination station 20, the number of parking spaces available for reservation can be six by securing two virtual parking spaces P_{V}. For the above reason, the reservation determination unit 43 determines that all of the five vehicles V at the origin station 10 can be reserved.

Since the car-sharing management apparatus 40 according to the embodiment described above determines whether vehicle rental reservation is possible based on the number of parking spaces available for reservation larger than the number of actual vacant parking spaces P_{A} at the destination station 20, it is possible to increase the number of vehicles available for reservation compared to a case where it is determined whether vehicle rental reservation is possible based on the number of actual vacant parking spaces P_{A}. In other words, even when the actual vacant parking spaces P_{A} are fully reserved, the car-sharing management apparatus 40 according to the present embodiment enables users to easily make reservations since the users can also reserve the virtual parking spaces P_{V}. For the above reason, even when there is a user who repeatedly makes and cancels short-term reservations in order to secure a rental vehicle for long periods of time, the car-sharing management apparatus 40 according to the present embodiment enables another user to make a reservation. Furthermore, with the car-sharing management apparatus 40 according to the present embodiment, since the number of reservations can be increased, compared to the related art, by the number of virtual parking spaces P_{V}, it is possible to reduce stand-by time of the staff members in charge of the vehicle dispatch-deadhead, thereby enhancing their work efficiency.

In addition, the above embodiment illustrates an example in which the present disclosure is applied to the one-way trip car-sharing system 1, in which the origin station 10 is different from the destination station 20. In some embodiments, the present disclosure can also be applied to the round-trip system, in which a user returns a rented vehicle to the same station where the vehicle are rented (i.e., the destination station and the origin station are the same.)

What is claimed is:

1. A car-sharing management apparatus configured to determine whether vehicle rental reservation is possible based on the number of parking spaces available for reservation at a destination station, wherein the car-sharing management apparatus is configured to obtain the number of parking spaces available for reservation by adding the number of virtual parking spaces to the number of actual vacant parking spaces at the destination station.

2. The car-sharing management apparatus according to claim 1, comprising a parking space determination unit configured to determine the number of parking spaces available for reservation,
wherein the car-sharing management apparatus is configured to, when the car-sharing management apparatus receives a reservation request from a user via a user terminal, determine whether the vehicle rental reservation is possible based on the number of parking spaces available for reservation determined by the parking space determination unit.

3. The car-sharing management apparatus according to claim 2, wherein the parking space determination unit is configured to determine the number of virtual parking spaces based on a dispatch-deadhead schedule.

4. The car-sharing management apparatus according to claim 2, wherein the parking space determination unit is configured to determine the number of virtual parking spaces based on a dispatch-deadhead capability of autonomous vehicle to be parked at the destination station.

5. A car-sharing system, comprising:
an origin station;
a destination station where vehicles that are rented at the origin station are to be parked; and
the car-sharing management apparatus according to claim 1.

6. The car-sharing system according to claim 5, wherein the destination station is the same as the origin station.

7. The car-sharing system according to claim 5, wherein the destination station is different from the origin station.

8. A car-sharing management method comprising:
obtaining the number of parking spaces available for reservation by adding the number of virtual parking spaces to the number of actual vacant parking spaces at a destination station; and
determining whether vehicle rental reservation is possible based on the number of parking spaces available for reservation.

9. A non-transitory computer-readable storage medium storing a program, the program comprising commands for causing a computer to:
obtain the number of parking spaces available for reservation by adding the number of virtual parking spaces to the number of actual vacant parking spaces at a destination station; and
determine whether vehicle rental reservation is possible based on the number of parking spaces available for reservation.
